(19) United States
(12) Patent Application Publication
(10) Pub. No.: US 2023/0088190 A1
(43) Pub. Date: Mar. 23, 2023

(54) UNIVERSAL ELECTRONIC DEVICE MOUNTING BRACKET

(71) Applicant: Resource Integrated Ltd., Richmond Hill (CA)

(72) Inventors: Antony Rubino, Richmond Hill (CA); Navpreet Singh, Woodstock (CA)

(21) Appl. No.: 17/826,900

(22) Filed: May 27, 2022

(30) Foreign Application Priority Data
Sep. 20, 2021 (CA) 3131350

(51) Int. Cl. F16M 11/06; F16M 13/02

(52) U.S. Cl. CPC F16M 11/06; F16M 13/02; F16M 2200/06

(57) ABSTRACT

In at least one embodiment a mounting bracket is disclosed having a body portion having a proximal outer surface and a distal outer surface, at least one transversely extending slot and at least one longitudinally extending slot extending therethrough, a first and second outwardly projecting retaining arm slidably received in the at least one transversely extending slot and movable between a first retracted position and a second extended position, a first vertically and second vertically projecting retaining arm slidably received in one of the at least one longitudinally extending slot and movable between a first retracted position and a second extended position, each of the first outwardly projecting retaining arm, second outwardly projecting retaining arm, first vertically projecting retaining arm and second vertically projecting retaining arm has at least one bend and a distal end, the distal end having a first vertically projecting retaining hook adapted for receiving an edge of an electronic device.

### FIELD

The present disclosure relates to brackets and related mounting devices for receiving a wide variety of electronic devices in an adjustable manner for display in a variety of applications.

### BACKGROUND

Mobile electronic devices are ubiquitous products in the current marketplace and take a wide variety of physical forms which can further include a number of specific features adapted for countless end-user applications.

This proliferation of electronic devices has resulted in a nearly limitless number of electronic devices all of which have differing dimensions. However, two features that are common to a large number of currently available electronic devices are a generally planar rectangular shape and a front-facing electronic touchscreen that permits the user to operate and interact with the electronic device.

Modern electronic devices commonly have a number of ancillary features such as cameras, connection ports, speakers, microphones and physical buttons all of which can be located in a number of areas on the device. As such, there is very little that can be considered “standard” about the general layout of available electronic devices.

Therefore, a problem is presented when trying to securely mount a variety of electronic devices to an underlying surface. The device must be secured in an adjustable manner to accommodate the differing dimensions of various electronic devices and which does not impede the user's ability to access the front facing touchscreen or any ancillary features that may be included on the particular electronic device under consideration.

For example, in sales applications, a retail store selling mobile devices may wish to display a number of available electronic devices to potential customers in a manner that permits the customer to experience the device to its fullest potential as intended by the manufacturer, but also in a manner that prevents theft or damage to these expensive and potentially delicate pieces of electronic equipment.

As such, there is a need for adjustable mounting brackets that can securely accept a wide variety of electronic devices and which can display the secured device in a tamper-proof manner that does not impede the user's ability to use the electronic device as intended by the manufacturer.

### BRIEF SUMMARY

It is contemplated that the present disclosure provides an adjustable universal mounting bracket for an electronic device that can securely accept a wide variety of electronic devices and which can display the secured device in a tamper-proof manner that does not impede the user's ability to use the electronic device as intended by the manufacturer.

In at least one embodiment, a mounting bracket is disclosed having a body portion having a proximal outer surface and a distal outer surface, the body portion having at least one transversely extending slot extending therethrough, the body portion having at least one longitudinally extending slot extending therethrough, a first outwardly projecting retaining arm, the first outwardly projecting retaining arm slidably received in one of the at least one transversely extending slots and movable between a first retracted position and a second extended position, a second outwardly projecting retaining arm, the second outwardly projecting retaining arm slidably received in one of the at least one transversely extending slot and movable between a first retracted position and a second extended position, a first vertically projecting retaining arm, the first vertically projecting retaining arm slidably received in one of the at least one longitudinally extending slot and movable between a first retracted position and a second extended position, a second vertically projecting retaining arm, the second vertically projecting retaining arm slidably received in one of the at least one longitudinally extending slot and movable between a first retracted position and a second extended position, such that each of the first outwardly projecting retaining arm, second outwardly projecting retaining arm, first vertically projecting retaining arm and second vertically projecting retaining arm have at least one bend and a distal end, each distal end having a vertically projecting retaining hook adapted for receiving an edge of an electronic device.

### DESCRIPTION OF THE FIGURES

The present disclosure will be understood in connection with the following FIGURES, in which:

FIG. 1A is a lower perspective view of an assembled universal electronic device mounting bracket in accordance with at least one embodiment of the present invention;

FIG. 1B is a bottom view of an assembled universal electronic device mounting bracket in accordance with at least one embodiment of the present invention;

FIG. 1C is a side view of an assembled universal electronic device mounting bracket in accordance with at least one embodiment of the present invention;

FIG. 2 is an exploded lower perspective view of a universal electronic device mounting bracket in accordance with at least one embodiment of the present invention;

FIG. 3 is an exploded lower perspective view of a body portion and a pivoting bracket of a universal electronic device mounting bracket in accordance with at least one embodiment of the present invention;

FIG. 4 is an assembled lower perspective view of a body portion and a pivoting bracket of a universal electronic device mounting bracket in accordance with at least one embodiment of the present invention;

FIG. 5 is a perspective view of an outwardly projecting retaining arm in accordance with at least one embodiment of the present invention;

FIG. 6 is a perspective view of a vertically projecting retaining arm in accordance with at least one embodiment of the present invention; and

FIG. 7 is a lower perspective view of an assembled universal electronic device mounting bracket holding an electronic device in accordance with at least one embodiment of the present invention.

### DETAILED DESCRIPTION OF THE EMBODIMENTS

It is contemplated that the present disclosure provides an adjustable universal mounting bracket for an electronic device that can securely accept a wide variety of electronic devices and which can display the secured device in a tamper-proof manner that does not impede the user's ability to use the electronic device as intended by the manufacturer.

It will be readily appreciated that all components discussed herein can be manufactured by way of any suitable process and out of any suitable material, as required by the specific end user application of the present universal electronic device mounting bracket.

Moreover, it will be readily appreciated that the individual components discussed herein can be manufactured to any suitable dimensions and can be formed as individual unitary components or as separate subcomponents suitably joined together, as required by the specific end user application of the present universal electronic device mounting bracket.

It will be appreciated that all bores discussed herein may be countersunk in order to provide appropriate clearance for the head of a mechanical fastener, as required by the particular end user application of the present universal electronic device mounting bracket and as will be appreciated by a skilled person.

In at least one embodiment, it is contemplated that the present disclosure provides a mounting bracket having a body portion, a first outwardly projecting retaining arm, a second outwardly projecting retaining arm, a first vertically projecting retaining arm and a second vertically projecting retaining arm. In some embodiments, it is contemplated that the mounting bracket further includes a pivoting bracket.

It is contemplated that the body portion has a proximal outer surface and a distal outer surface. In some embodiments, it is contemplated that the proximal outer surface abuts and adjoins the pivoting bracket, as discussed in further detail herein.

In some embodiments, it is contemplated that the body portion has a first proximal portion and a second distal portion such that the first proximal portion contains the proximal outer surface and the second distal portion contains the distal outer surface. In these embodiments, it is contemplated that the first proximal portion of the body portion can be securely joined to the second distal portion of the body portion by way of a mechanical fastener or by any other suitable technique, as discussed in further detail herein.

It is fluffier contemplated that the body portion has at least one transversely extending slot extending therethrough from a first vertically extending distal edge of the body portion to a second vertically extending distal edge of the body portion. In some embodiments, it is contemplated that the body portion has two or more transversely extending slots extending therethrough, as discussed herein.

In some embodiments, it is contemplated that at least one of the at least one transversely extending slots is positioned between a horizontally extending centerline of the body portion and an upper or lower distal edge of the body portion.

Similarly, it is contemplated that the body portion has at least one longitudinally extending slot extending therethrough from an upper distal edge of the body portion and a lower distal edge of the body portion. In some embodiments, it is contemplated that the body portion has two or more longitudinally extending slots extending therethrough, as discussed herein.

In some embodiments, it is contemplated that at least one of the at least one longitudinally extending slots is positioned between a vertically extending centerline of the body portion and a vertically extending distal edge of the body portion.

In some embodiments, it will be appreciated that the transversely extending slots are positioned directly adjacent and perpendicular to the longitudinally extending slots in a layered manner, as will be discussed in further detail herein.

In some embodiments, it is contemplated that each transversely extending slot and each longitudinally extending slot can have a first slot wall, a second slot wall, a slot lower portion and slot upper portion, while in other embodiments each transversely extending slot and each longitudinally extending slot may include one or more of a first slot wall, a second slot wall, a slot lower portion and an slot upper portion.

As such, it will be appreciated that the transversely extending slots and the vertically extending slots may be defined by continuous slot walls, continuous slot lower portions and continuous slot upper portions. In other embodiments, it is contemplated that the transversely extending slots and the vertically extending slots may be defined by discontinuous slot walls, discontinuous slot lower portions and discontinuous slot upper portions.

In other embodiments, it is contemplated that the transversely extending slots and the vertically extending slots may be defined by a mixture of continuous and discontinuous slot walls, continuous and discontinuous slot lower portions and continuous and discontinuous slot upper portions, as will be appreciated by the skilled person and as discussed in further detail herein.

It will be appreciated that each of the transversely and longitudinally extending slots can take a number of cross-sectional profiles depending on the corresponding cross-sectional profile of the respective retaining arm that is received in the slot, as discussed in further detail below. In at least one embodiment, it is contemplated that the transversely and longitudinally extending slots have a rectangular cross-sectional profile, however other arrangements are also contemplated and will be readily appreciated by the skilled person.

In at least one embodiment, it is contemplated that the first outwardly projecting retaining arm is slidably received in one of the at least one transversely extending slots and is movable between a first retracted position and a second extended position. Similarly, it is contemplated that the second outwardly projecting retaining arm is slidably received in one of the at least one transversely extending slots and movable between a first retracted position and a second extended position. In these embodiments, it is contemplated that the first outwardly projecting retaining arm is oriented in relation to the second outwardly projecting retaining arm in an opposed manner, as will be discussed in further detail herein.

In some embodiments, it is contemplated that the present mounting bracket further includes a third outwardly projecting retaining arm slidably received in one of the at least one transversely extending slots and movable between a first retracted position and a second extended position.

Similarly, in these embodiments it is contemplated that a fourth outwardly projecting retaining arm is slidably received in one of the at least one transversely extending slots and movable between a first retracted position and a second extended position. In these embodiments, it is contemplated that the third outwardly projecting retaining arm is oriented in relation to the fourth outwardly projecting retaining arm in an opposed manner, as will be discussed in further detail herein.

In some embodiments, it is contemplated that there are two transversely extending slots and the first outwardly projecting retaining arm is received in one of these two transversely extending slots and the second outwardly projecting retaining arm is received in the other of these two transversely extending slots. In other embodiments, it is contemplated that the outwardly projecting retaining arms are sized such that these components share a single transversely extending slot.

In some embodiments, it is contemplated that there are four transversely extending slots and the first outwardly projecting retaining arm is received in one of these four transversely extending slots, the second outwardly projecting retaining arm is received in another of these four transversely extending slots, a third outwardly projecting retaining arm is received in another of these four transversely extending slots and a fourth outwardly projecting retaining arm is received in the last of these four transversely extending slots.

It is contemplated that the first vertically projecting retaining arm is slidably received in one of the at least one longitudinally extending slots and movable between a first retracted position and a second extended position. Similarly, the second vertically projecting retaining arm is slidably received in one of the at least one longitudinally extending slots and movable between a first retracted position and a second extended position.

In some embodiments, it is contemplated that there are two longitudinally extending slots and the first vertically projecting retaining arm is received in one of these two longitudinally extending slots and the second vertically projecting retaining arm is received in the other of these two longitudinally extending slots. In other embodiments, it is contemplated that the first vertically and second vertically projecting retaining arms are sized such that these components share a single longitudinally extending slot. In these embodiments, it is contemplated that the first vertically projecting retaining arm is oriented in relation to the second vertically projecting retaining arm in an opposed manner, as will be discussed in further detail herein.

It is contemplated that each of the first outwardly projecting retaining arm, the second outwardly projecting retaining arm, the third outwardly projecting retaining arm (when present), the fourth outwardly projecting retaining arm (when present), the first vertically projecting retaining arm and the second vertically projecting retaining arm have at least one bend and a distal end.

In at least one embodiment, it is contemplated that the at least one bend can be an offset upward bend. In other embodiments, it is contemplated that the at least one bend can be a double offset transverse and upward bend, among other arrangements that will be readily appreciated by the skilled person.

It is contemplated that any number of further types of bends can be used in connection with the present disclosure as required by the particular end user application under consideration, including but not limited to “S-shaped” bends, “U-shaped” bends, elbow bends, quarter bends, offset bends, offset transverse bends, offset upward bends, double offset transverse and upward bends, double offset bends, and 0-to-90 degree bends, and it is further contemplated that these bends can be used in both vertical and horizontal configurations.

It is further contemplated that each distal end of each retaining arm has an upwardly projecting retaining hook adapted for securely receiving and retaining an edge of an electronic device, as discussed in further detail herein.

In some embodiments, it is contemplated that that each of the first outwardly projecting retaining arm, the second outwardly projecting retaining arm, the third outwardly projecting retaining arm (when present), the fourth outwardly projecting retaining arm (when present), the first vertically projecting retaining arm and the second vertically projecting retaining arm have a proximal end. In some embodiments, it is contemplated that this proximal end has a bore that is adapted to receive the head of a mechanical fastener.

In some embodiments, it is contemplated that a corresponding mechanical fastener can be provided that secures at least one of the retaining arms relative to the corresponding slot that the retaining arm is slidably received in, thereby fixing the retaining arm in place relative to the slot, as discussed in further detail herein.

As such, it is contemplated that the retaining arms are slidably received in a corresponding slot but can also be secured within the slot by the corresponding mechanical fastener once the retaining arm has been positioned appropriately at the first retracted position, the second extended position, or at any position between the first retracted position and the second extended position, based on the needs of the end user application under consideration.

In some embodiments, it is contemplated that the present mounting bracket further includes a pivoting bracket having a generally planar central mounting surface, a first outwardly projecting mounting flange and a second outwardly projecting mounting flange. It is contemplated that the generally planar mounting surface abuts and adjoins the proximal outer surface of the body portion, as discussed in further detail herein.

In some embodiments, it is contemplated that the first outwardly projecting mounting flange and the second outwardly projecting mounting flange can each be located along a respective distal edge of the generally planar mounting surface. It is further contemplated that the first outwardly projecting mounting flange and the second outwardly projecting mounting flange can each contain at least one bore. In some embodiments, it is contemplated that these bores are countersunk to accommodate the head of a suitable mechanical fastener.

In this way, it is contemplated that a suitable mechanical fastener can be inserted into the bores provided in the outwardly projecting mounting flanges and secured to an underlying surface, thereby securely mounting the present mounting bracket to an underlying surface in a secure yet pivotable manner.

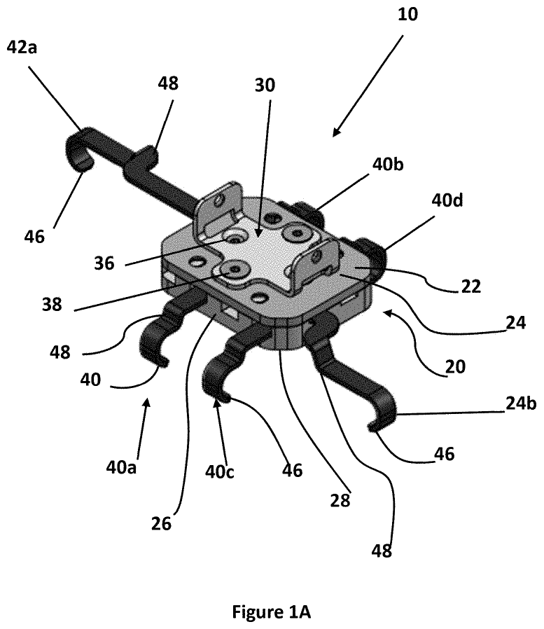

With reference to FIGS. 1A, 1B, 1C, 2 and 7 at least one embodiment of a mounting bracket in accordance with the present disclosure is illustrated. Mounting bracket 10 has a body portion 20, a pivoting bracket 30, a first outwardly projecting retaining arm 40a opposed from a second outwardly projecting retaining arm 40b, a third outwardly projecting retaining arm 40c opposed from a fourth outwardly projecting retaining arm 40d, and a first vertically projecting retaining arm 42a opposed from a second vertically projecting retaining arm 42b.

In this embodiment, body portion 20 has a first proximal portion 22 having a proximal outer surface 24 and a second distal portion 26 having a distal outer surface 28.

It is contemplated that each of first outwardly projecting retaining arm 40a, second outwardly projecting retaining arm 40b, third outwardly projecting retaining arm 40c fourth outwardly projecting retaining arm 40d, a first vertically projecting retaining arm 42a and second vertically projecting retaining arm 42b are each slidably received in a corresponding slot and movable between a first retracted position and a second extended position, as discussed in further detail below.

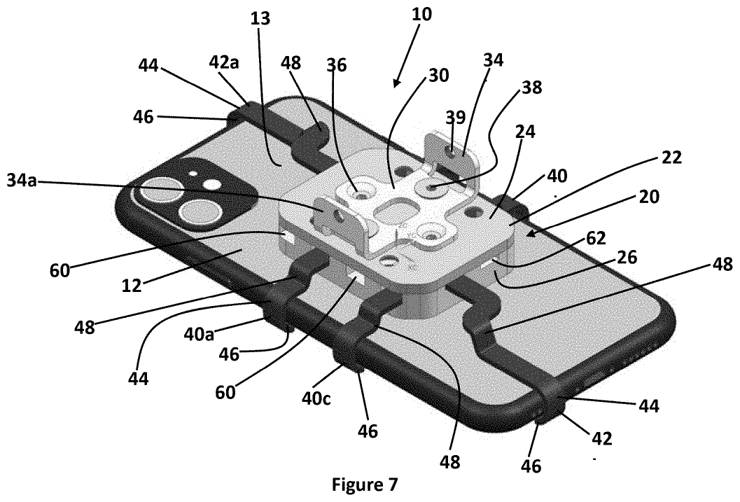

In this embodiment, each of first outwardly projecting retaining arm 40a, second outwardly projecting retaining arm 40b, third outwardly projecting retaining arm 40c, fourth outwardly projecting retaining arm 40d, first vertically projecting retaining arm 42a and second vertically projecting retaining arm 42b have a distal end having a vertically projecting retaining hook 46 adapted to securely receive and retain the edge of an electronic device 12, as can be seen in FIG. 7.

Moreover, in this embodiment each of the first outwardly projecting retaining arm 40a, the second outwardly projecting retaining arm 40b, the third outwardly projecting retaining arm 40c and the fourth outwardly projecting retaining arm 40d have a bend 48 that is an offset upward bend.

Furthermore, in this embodiment each of the first vertically projecting retaining arm 42a and the second vertically projecting retaining arm 42b have a bend 48 that is a double offset transverse and upward bend.

In this embodiment, pivoting bracket 30 has a generally planar mounting surface 32, a first outwardly projecting mounting flange 34a and a second outwardly projecting mounting flange 34b. Generally planar mounting surface 32 has at least one bore 36 and is secured to the proximal outer surface 24 of the first proximal portion 22 of the body portion 20 by way of a mechanical fastener 38. It is further contemplated that any one at least one bore 36 may be countersunk as necessary.

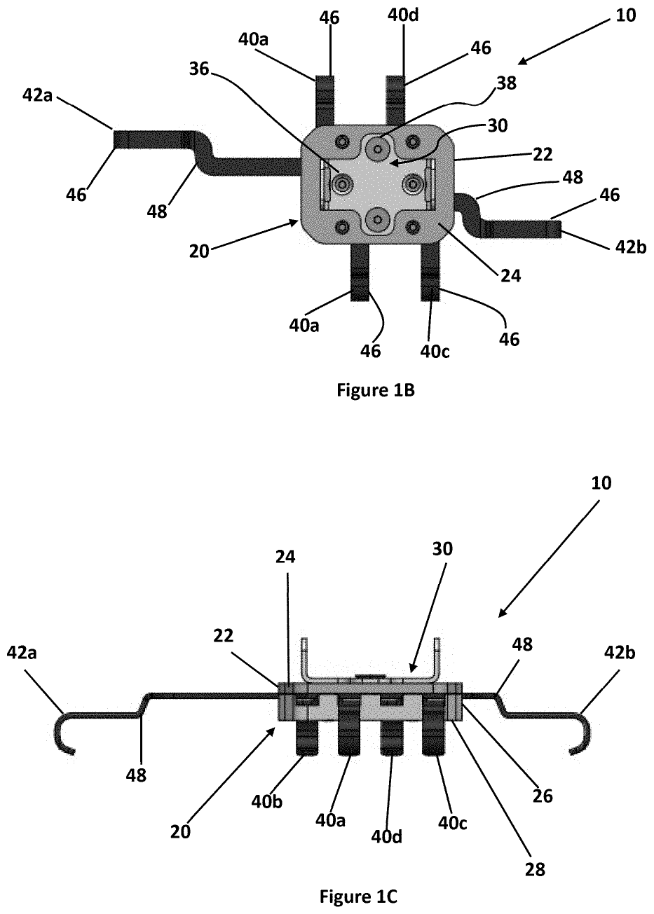

With reference to FIG. 2, it can be seen that each of first outwardly projecting retaining arm 40a, second outwardly projecting retaining arm 40b, third outwardly projecting retaining arm 40c and fourth outwardly projecting retaining arm 40d are slidably received in a corresponding transversely extending slot. Similarly, each of first vertically projecting retaining arm 42a and second vertically projecting retaining arm 42b are slidably received in a corresponding longitudinally extending slot.

It is contemplated that a corresponding mechanical fastener 64a may be provided adjacent to at least one of the transversely extending slots and/or at least one of the longitudinally extending slots. In this way, it is contemplated that mechanical fastener 64a can secure an adjacent retaining arm relative to the corresponding slot that the retaining arm is slidably received in, thereby fixing the retaining arm in place relative to the slot and body portion 20.

As such, it is contemplated that each retaining arm is slidably received in a corresponding slot such that it can be moved between a first retracted position and a second extended position, but each retaining arm can also be secured within its respective slot by corresponding mechanical fastener 64a once the retaining arm has been positioned appropriately, as can be seen in FIG. 2.

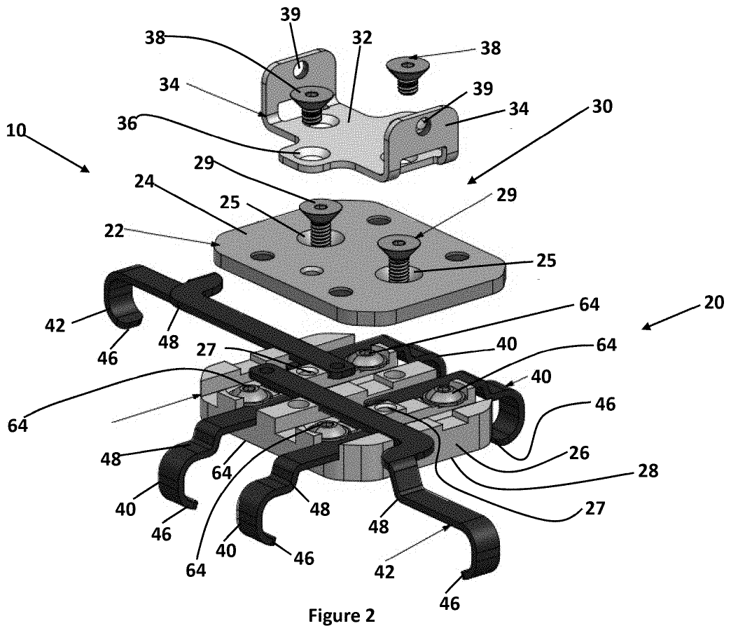

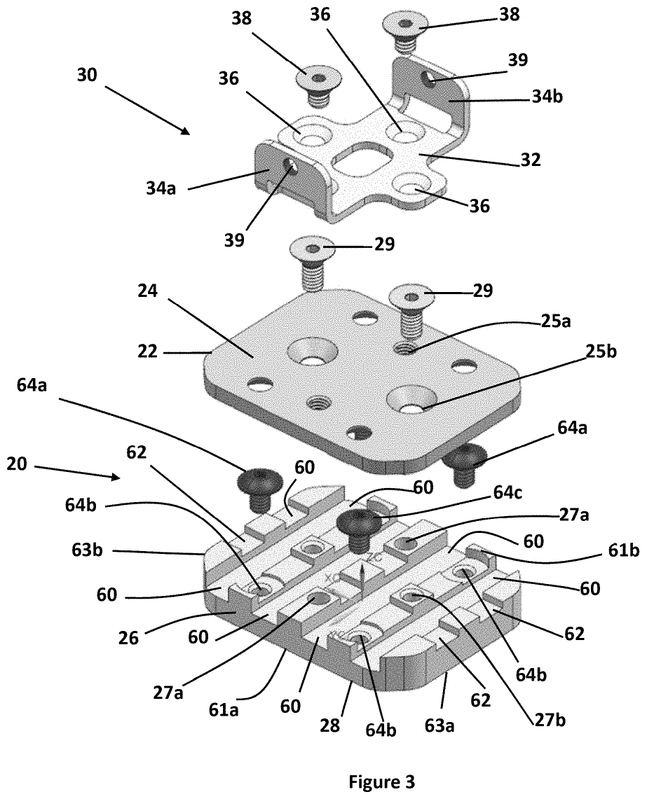

Turning to FIGS. 3 and 4, at least one embodiment of a body portion and a pivoting bracket is illustrated. Body portion 20 has a first proximal portion 22 having a proximal outer surface 24 and a second distal portion 26 having a distal outer surface 28.

Pivoting bracket 30 has a generally planar mounting surface 32, a first outwardly projecting mounting flange 34a and a second outwardly projecting mounting flange 34b. Generally planar mounting surface 32 has a number of bores 36 and is secured to the proximal outer surface 24 of the first proximal portion 22 of the body portion 20 by way of two corresponding mechanical fasteners 38 that are inserted through bores 36 into corresponding bores 25a (provided in the first proximal portion 22 of the body portion 20) and corresponding bores 27a (provided in the second distal portion 26 of the body portion 20), thereby securing pivoting bracket 30 to the first proximal section 22 and second distal portion 26 of body portion 20.

It is further contemplated that any of bores 36, 25a, 27a, 39 may be countersunk as require by the particular application.

Further, it is contemplated that each of first outwardly projecting mounting flange 34a and second outwardly projecting mounting flange 34b have a bore 39 that can be used to secure the pivoting bracket 30 to an underlying surface in a secure yet pivotable manner.

It is further contemplated that any of bores 36, 25a, 27a, 39 may be countersunk as require by the particular application.

In this embodiment, first proximal portion 22 has a proximal outer surface 24 and a number of bores 25a, 25b. Second distal portion 26 has a distal outer surface 28 and a number of corresponding bores 27a, 27b. In this way, it is contemplated that two mechanical fasteners 29 can be inserted through bores 25b into corresponding bores 27b, thereby securing first proximal section 22 to second distal portion 26.

In this embodiment, it is further contemplated that second distal portion 26 of body portion 20 has a four integrally formed transversely extending slots 60. It is contemplated that each transversely extending slot 60 extends through the distal portion 26 of body portion 20 from a first vertical distal edge 61a to a second vertical distal edge 61b. In this embodiment, it can be seen that transversely extending slots 60 each have a continuous lower slot portion and semi-continuous opposing slot walls, as can be seen in FIG. 3.

In this way, it is contemplated that each outwardly projecting retaining arm 40a, 40b, 40c, 40d can be slidably received in a corresponding transversely extending slot 60. It is further contemplated that each outwardly projecting retaining arm 40a, 40b, 40c, 40d can be secured relative to transversely extending slot 60 by way of mechanical fastener 64a that is inserted into a corresponding bore 64b that is provided adjacent to each respective transversely extending slots 60 in second distal portion 26 of body portion 20, as can also be seen in FIG. 2.

In this embodiment, it is contemplated that bore 64b may be suitably countersunk in order to receive the head of mechanical fastener 64a when first proximal section 22 is secured to second distal portion 26, as will be appreciated by the skilled person.

In this way, it is contemplated that the head of mechanical fastener 64a can frictionally engage an upper surface of outwardly projecting retaining arm 40a, 40b, 40c, 40d, thereby securing outwardly projecting retaining arm 40a, 40b, 40c, 40d relative to a corresponding transversely extending slot 60 and fixing outwardly projecting retaining arm 40a, 40b, 40c, 40d in place relative to transversely extending slot 60 and, as a result, body portion 20.

In this embodiment, it is further contemplated that second distal portion 26 of body portion 20 has a two integrally formed longitudinally extending slots 62. It is contemplated that each transversely extending slot 62 extends through distal portion 26 of body portion 20 from a first horizontal distal edge 63a to a second horizontal distal edge 63b. In this embodiment, it can be seen that longitudinally extending slots 62 each have a discontinuous lower slot portion and discontinuous opposing slot walls, as can be seen in FIG. 3.

In this way, it is contemplated that each vertically projecting retaining arm 42a, 42b can be slidably received in a corresponding longitudinally extending slot 62, as can also be seen in FIG. 2.

In this embodiment, it will be appreciated that transversally extending slots 60 are positioned adjacent and perpendicular to the longitudinally extending slots 62 in a layered manner. As such, it will be appreciated that transversely extending slots 60 are defined by continuous slot walls and semi-continuous slot lower portions and vertically extending slots 62 are positioned directly adjacent to longitudinally extending slots 62 and, as a result, vertically extending slots 62 are defined by discontinuous slot walls and discontinuous slot lower portions.

It will also be appreciated in this embodiment, transversally extending slots 60 and longitudinally extending slots 62 have a generally rectangular cross-sectional profile, however other arrangements are also contemplated and will be readily appreciated by the skilled person.

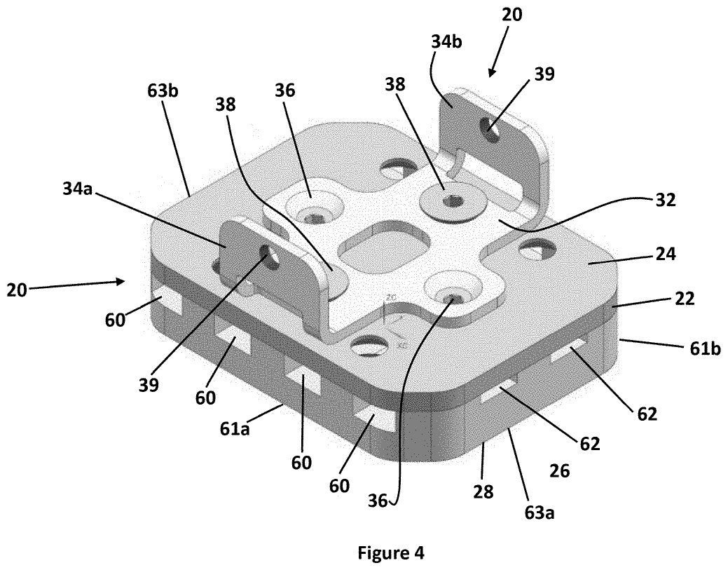

Turning to FIG. 5, at least one embodiment of an outwardly projecting retaining arm is illustrated. In this embodiment, outwardly projecting retaining arm 40 extends between a proximal end 43 and a distal end 44. It is contemplated that distal end 44 has a vertically projecting retaining hook 46 that is adapted to securely receive and retain the edge of a mobile phone.

Moreover, in this embodiment it is contemplated that outwardly projecting retaining arm 40 has a bend 48 located between the proximal end 43 and the distal end 44 of the outwardly projecting retaining arm 40. In this embodiment, bend 48 is an offset upward bend. It is further contemplated that proximal end 43 has a bore 49 that can receive a mechanical fastener.

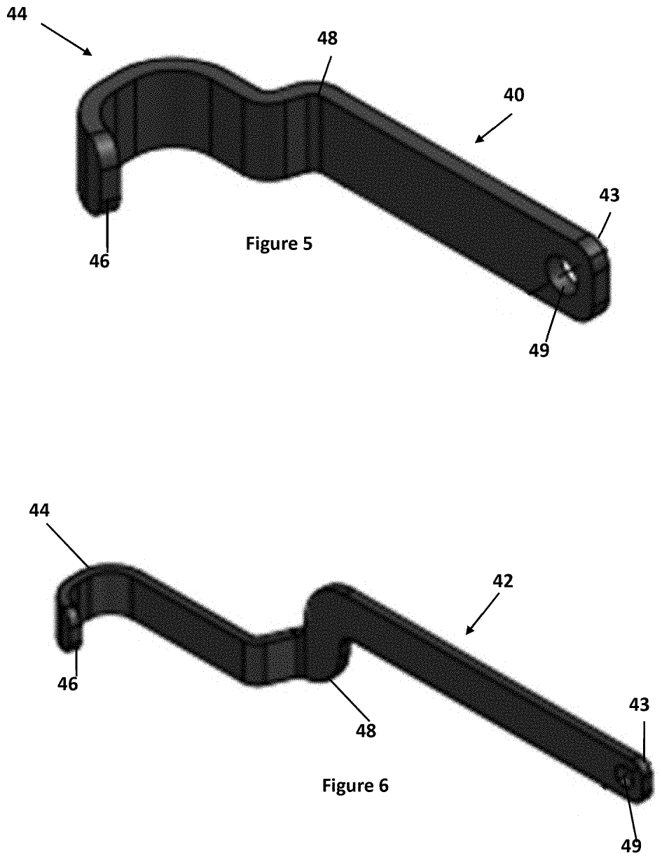

Turning to FIG. 6, at least one embodiment of a vertically projecting retaining arm is illustrated. In this embodiment, vertically projecting retaining arm 42 extends between a proximal end 43 and a distal end 44. It is contemplated that distal end 44 has a vertically projecting retaining hook 46 that is adapted to securely receive and retain the edge of a mobile phone.

Moreover, in this embodiment it is contemplated that vertically projecting retaining arm 40 has a bend 48 located between the proximal end 43 and the distal end 44 of the vertically projecting retaining arm 40. In this embodiment, bend 48 is a double offset transverse and upward bend. It is further contemplated that proximal end 43 has a bore 49 that can receive a mechanical fastener.

With reference to FIG. 7, at least one embodiment of an assembled mounting bracket holding a mobile phone is illustrated. In this embodiment, mounting bracket 10 has a body portion 20 having four transversely extending slots 60. Each transversely extending slot 60 slidably receives one of first outwardly projecting retaining arm 40a, second outwardly projecting retaining arm 40b, third outwardly projecting retaining arm 40c and fourth outwardly projecting retaining arm 40d.

Moreover, each of first outwardly projecting retaining arm 40a, second outwardly projecting retaining arm 40b, third outwardly projecting retaining arm 40c and fourth outwardly projecting retaining arm 40d has a distal end 44 that has a vertically projecting retaining hook 46 that is adapted to securely receive and retain the edge of a mobile phone 12.

In this embodiment, each of the first outwardly projecting retaining arm 40a, the second outwardly projecting retaining arm 40b, the third outwardly projecting retaining arm 40c and the fourth outwardly projecting retaining arm 40d have a bend 48 that is an offset upward bend.

Similarly, body portion 20 has two longitudinally extending slots 62. Each longitudinally extending slot 62 slidably receives one of first vertically projecting retaining arm 42a and second vertically projecting retaining arm 42b.

Moreover, each of first vertically projecting retaining arm 42a and second vertically projecting retaining arm 42b has a vertically projecting retaining hook 46 that is adapted to securely receive and retain the edge of a mobile phone 12.

Furthermore, in this embodiment each of the first vertically projecting retaining arm 42a and the second vertically projecting retaining arm 42b have a bend 48 that is a double offset transverse and upward bend.

It is further contemplated that a rear surface 13 of mobile phone 12 can abut the distal outer surface (not shown) of the body portion 20 when mobile phone 12 is securely mounted in mounting bracket 10.

Finally, mounting bracket 10 has a pivoting bracket 30 that has a generally planar mounting surface 32, a first outwardly projecting mounting flange 34a and a second outwardly projecting mounting flange 34b. Generally planar mounting surface 32 has at least one bore 36 and is secured to the proximal outer surface 24 of the first proximal portion 22 of the body portion 20 by way of a mechanical fastener 38.

It is further contemplated that each of first outwardly projecting mounting flange 34a and second outwardly projecting mounting flange 34b have a bore 39 that can be used to secure the pivoting bracket 30 to an underlying surface in a secure yet pivotable manner.

In this way, the present disclosure provides a universal device mounting bracket that can be adjusted to accept a wide variety of electronic devices in a secure and tamper-proof manner and which can be mounted to a suitable underlying surface in a secure yet pivotable manner, such that a user of the electronic device can access the front-mounted touchscreen and various ancillary components, such as, but not limited to, a speaker, a microphone, a camera, an input “home” button or a connection port.

The embodiments described herein are intended to be illustrative of the present compositions and methods and are not intended to limit the scope of the present invention. Various modifications and changes consistent with the description as a whole and which are readily apparent to the person of skill in the art are intended to be included. The appended claims should not be limited by the specific embodiments set forth in the examples but should be given the broadest interpretation consistent with the description as a whole.

What is claimed is:

1. A mounting bracket comprising:
A body portion having a proximal outer surface and a distal outer surface, the body portion having at least one transversely extending slot extending therethrough, the body portion having at least one longitudinally extending slot extending therethrough;
a first outwardly projecting retaining arm, the at least first outwardly projecting retaining arm slidably received in one of the at least one transversely extending slot and movable between a first retracted position and a second extended position;
a second outwardly projecting retaining arm, the at least second outwardly projecting retaining arm slidably received in one of the at least one transversely extending slot and movable between a first retracted position and a second extended position;
A first vertically projecting retaining arm, the first vertically projecting retaining arm slidably received in one of the at least one longitudinally extending slot and movable between a first retracted position and a second extended position;
A second vertically projecting retaining arm, the second vertically projecting retaining arm slidably received in one of the at least one longitudinally extending slots and movable between a first retracted position and a second extended position;
wherein each of the first outwardly projecting retaining arm, the second outwardly projecting retaining arm, the first vertically projecting retaining arm and the second vertically projecting retaining arm have at least one bend and a distal end, each distal end having a vertically projecting retaining hook adapted for receiving an edge of an electronic device.

2. The mounting bracket of claim 1, further comprising a pivoting bracket, the pivoting bracket comprising:
A generally planar central mounting surface, the generally planar mounting surface abutting the proximal outer surface of the body portion;
a first outwardly projecting mounting flange, the first mounting arm containing at least one bore; and
a second outwardly projecting mounting flange, the second mounting arm containing at least one bore.

3. The mounting bracket of claim 2, wherein the generally planar central mounting surface further comprises at least one bore.

4. The mounting bracket of claim 3, wherein the proximal outer surface further includes at least one external bore and the generally planar central mounting surface is secured to the proximal outer surface of the body portion by way of at least one mechanical fastener, the mechanical fastener extending through the at least one bore and into the at least one external bore.

5. The mounting bracket of claim 1, wherein at least one of the at least one longitudinally extending slot is positioned between a longitudinal centerline of the body portion and a distal vertical edge of the body portion.

6. The mounting bracket of claim 1, wherein at least one of the at least one transversely extending slot is positioned between a horizontal centerline of the body portion and at least one of a distal upper edge of the body portion and a distal lower edge of the body portion.

7. The mounting bracket of claim 1, wherein the at least one bend is selected from the group of: an offset transverse bend and a double offset transverse and upward bend.

8. The mounting bracket of claim 1, wherein at least one of the first outwardly projecting retaining arm, the second outwardly projecting retaining arm, the first vertically projecting retaining arm and the second vertically projecting retaining arm is secured relative to the body portion by way of a mechanical fastener.

9. The mounting bracket of claim 1, wherein at least one of the first outwardly projecting retaining arm, the second outwardly projecting retaining arm, the first vertically projecting retaining arm and the second vertically projecting retaining arm has a proximal end, the proximal end having a bore for receiving a mechanical fastener.

10. The mounting bracket of claim 1, wherein at least one of the at least one transversely extending slot and at least one of the at least one longitudinally extending slot has a rectangular cross-sectional profile.

11. The mounting bracket of claim 1, wherein the body portion is comprised of a first proximal portion and a second distal portion, the first proximal portion containing the proximal outer surface, the second distal portion containing the distal outer surface.

12. The mounting bracket of claim 1, wherein the first proximal portion is secured to the second distal portion by way of a mechanical fastener.

13. The mounting bracket of claim 1, further comprising:
a third outwardly projecting retaining arm, the third outwardly projecting retaining arm slidably received in one of the at least one transversely extending slot and movable between a first retracted position and a second extended position;
a fourth outwardly projecting retaining arm, the fourth outwardly projecting retaining arm slidably received in one of the at least one transversely extending slot and movable between a first retracted position and a second extended position.
